(19) United States
(12) Patent Application Publication
(10) Pub. No.: US 2010/0170152 A1
(43) Pub. Date: Jul. 8, 2010

(54) Maple spout with interior chamber and maple syrup production system using same

(75) Inventor: Timothy D. Perkins, Richmond, VT (US)

Correspondence Address: OPTICUS IP LAW, PLLC, 7791 ALISTER MACKENZIE DRIVE, SARASOTA, FL, 34240, US

(73) Assignee: UNIVERSITY OF VERMONT AND STATE AGRICULTURAL COLLEGE

(21) Appl. No.: 12/657,340

(22) Filed: Jan. 19, 2010

Related U.S. Application Data
(63) Continuation-in-part of application No. 12/286,032, filed on Sep. 26, 2008.

(51) Int. Cl. A01G 23/14; A01G 1/00

(52) U.S. Cl. 47/52; 47/58.1 R

(57) ABSTRACT

A maple syrup production spout with an interior chamber is disclosed. The spout is designed for use with vacuum-based maple syrup production systems. The interior chamber serves as a reservoir that allows the vacuum to accumulate, thereby facilitating the flow of sap from the tap hole, through the spout and into the dropline. The interior chamber also facilitates reduced liquid-liquid contact between the tubing system and the taphole, which improves the cleanliness of the tap hole and increases sap yield. Methods of using the spout in maple syrup production system are also disclosed.

### CROSS-REFERENCE TO RELATED APPLICATIONS

The present application is a continuation-in-part application of U.S. patent application Ser. No. 12/286,032, entitled “Maple syrup production spout with backflow check valve,” and filed on Sep. 26, 2008, which application is incorporated by reference herein.

The present application is also related to U.S. patent application Ser. No. ______, entitled “Maple syrup line system with increased diameter lines and fittings,” filed on the same day as the present application, and which application is incorporated by reference herein.

### FIELD OF THE INVENTION

The present invention relates generally to maple syrup production, and in particular relates to a maple syrup spout with an internal reservoir and a maple syrup production system that uses the maple syrup spout.

### BACKGROUND ART

Maple syrup production involves drilling holes into (i.e., “tapping”) maple trees, collecting the sap that exudes from the wound, and then reducing or “sugaring” down the sap using reverse osmosis and evaporators to form the final syrup. Details of maple syrup production are described in the publication entitled “North American Maple Syrup Producers Manual” (second edition), produced by Ohio State University, in cooperation with the North American Maple Syrup Council, and edited by Heiligmann, Koelling and Perkins, which is incorporated by reference herein by way of background information.

The traditional way of collecting maple sap uses buckets at the tap source. The sap is then collected in a tank and then transported to the “sugarhouse” for processing. Over the years, a variety of specialized hardware has been developed for this task, including both sap spouts (also called “maple syrup spouts”) and specialized sap collection buckets or bags. For many years, however, the basic techniques of maple syrup and sugar production remained essentially unchanged.

More recently, modern syrup producers have replaced the traditional bucket collection system with a tubing system that includes special spouts (usually 19/64″, 5/16″ or 7/16″ outside diameter (OD)) and plastic tubing “droplines” (usually 5/16″ inside diameter (ID) and about 18″ to 36″ in length) connected to the various spouts. The droplines are then connected to lateral lines (also usually formed from 5/16″ ID plastic tubing) that run between different maple trees. The lateral lines are in turn connected to one or more “main lines” (usually ¾″ to 2″ diameter) that run to the sugar house. Such systems are described in, for example, U.S. Pat. Nos. 2,877,601, 2,944,369, 3,046,698, and 3,057,115, and may either be gravity fed or utilize a vacuum pump to move the sap to a central collection point (e.g., an evaporator in the sugarhouse).

The sap flows from the tree through the spout and then through the line system when the pressure within the tree is greater than that in the lines. The line system then eventually conveys the sap to the evaporator. To facilitate the extraction and transportation of the sap from the tree and to the evaporator, some systems use a pump to pull a vacuum within the line system. This increases the pressure differential between the inside of the line system and the tree, thereby increasing the volume of sap flow as compared to that which would naturally occur by gravity.

The typical spouts used in maple production have either a single straight through passageway of a single diameter connected to 5/16″ ID tubing, or a single passageway with a 80-90° bend to divert sap downward into the 5/16″ ID tubing system. In some cases, the spout is separated into two distinct pieces, the spout adapter, with one end that inserts into the tree and another end that inserts into the second spout part, the spout stub, which connects to the 5/16″ ID tubing. Thus, the prior art spouts have what is essentially a single internal passageway to convey the sap from the taphole to the tubing. This internal passageway (channel) is typical very narrow and has a reasonably constant diameter or a slight taper from the spout tip to the part connecting with the 5/16″ ID tubing. This channel needs to support the vacuum while also accommodating the flow of sap out of the tree and to the 5/16″ ID tubing.

### SUMMARY OF THE INVENTION

Current maple industry practice utilizes a line system to collect sap from the tree and deliver it to the evaporator of a maple syrup production system. The sap and gases from the tree move downward in the system from the taphole, through the maple syrup spout, down the drop lines and lateral lines and toward the larger mainline due to gravity and the pull of the vacuum in the lines. The gases move faster in the lines, creating turbulence and resulting in reduced sap movement. In some cases (and particularly in cases where 5/16″ ID lines or smaller ID lines are used), portions of the drop lines and/or lateral lines are almost fully occupied by sap, resulting in reduced vacuum transfer to the taphole, which reduces sap yield.

Accordingly, an aspect of the invention is a spout that includes a main body section having an interior chamber that serves as a reservoir where vacuum can accumulate and where sap can also accumulate during its flow from a nose section and through the main body section to the drop line. The interior chamber facilitates reduced liquid-liquid contact between the tubing system and taphole as compared to prior art maple syrup spouts. This serves to restrict microbial movement from the tubing to the taphole and results in a cleaner taphole and higher sap yield as part of a maple syrup production system that utilizes a line system under vacuum to convey sap from the maple tree.

Additional features and advantages of the invention are set forth in the detailed description that follows, and in part will be readily apparent to those skilled in the art from that description or recognized by practicing the invention as described herein, including the detailed description that follows, the claims, as well as the appended drawings.

It is to be understood that both the foregoing general description and the following detailed description present embodiments of the invention are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention, and together with the description serve to explain the principles and operations of the invention.

### BRIEF DESCRIPTION OF THE DRAWINGS

FIG. 1 is a schematic diagram of a vacuum-based maple syrup production system that uses the spout of the present invention;

FIG. 2 is a close-up view of an example embodiment of the spout of the present invention as used in the system of FIG. 1, and showing an example embodiment of a backflow check valve geometry in the “flow” operational state;

FIG. 3 is the same as FIG. 2, but illustrating the operation of the backflow check valve in the closed position associated with the “blocking” operational state;

FIG. 4 and FIG. 5 are similar to FIG. 2 and FIG. 3, respectively, and illustrate another example embodiment of a backflow check valve that uses a floating disc;

FIG. 6 is a schematic side view of an example embodiment of the maple syrup production spout of the present invention that is formed by retrofitting a commonly used plastic maple syrup production spout;

FIG. 7 is an exploded view of an example of the spout of FIG. 6 wherein the spout comprises a spout section and a mating adapter section;

FIG. 8 is a cross-sectional view of spout section taken in the X-Z plane that illustrates an example embodiment wherein the spout of FIG. 6 includes at least one groove formed in the chamber so as to allow sap to flow through the spout section from the input channel to the output channel;

FIG. 9 is a side view of a spout that includes a spout connected to a backflow check valve, wherein the spout does not include backflow-check capability;

FIG. 10 is similar to FIG. 2 and illustrates an example embodiment of the spout that does not include backflow check-valve capability but includes an interior chamber that is larger than the input and output channels;

FIGS. 11 and 12 are example side views and FIGS. 14 and 15 are corresponding cut-away front-on views of another example of spout that includes an interior chamber but no blocking member arranged therein;

FIG. 16 is a side view that shows an example spout with nose section engaged with the tree tap hole (shown in cross-section), with the syrup flowing out of the tap hole and through the spout and into dropline over general flow path;

FIG. 17 is a similar to FIG. 9 and illustrates an example embodiment of a spout 10 that includes a spout with a single-size channel and a chamber unit having an interior chamber, with the chamber unit fluidly connected to the spout output end; and

FIG. 18 is similar to FIG. 17 and illustrates an example embodiment where the chamber unit is arranged within a drop line and is within a distance D from the spout output end.

### DETAILED DESCRIPTION OF INVENTION

In the description below, the term “fluidly connected” generally includes techniques known in the art of maple syrup production to connect fluid-carrying parts of the production system so that fluid can flow between or through the parts. An exemplary fluid connection technique is a “press fit,” where the end of one part (e.g., a drop line 210, described below) is slid over and pressed onto the end of another part (e.g., a fitting 330 with ridges 332, as described below) to provide a snug fit that is water-tight and vacuum tight. Other fluid connection techniques that are available employ threaded parts or snap-fit parts. However, the present invention is described below using the “press fit” connection technique because it is presently the most widely accepted connection technique in the maple syrup industry.

Also, while the present invention works well with 5/16″ inside diameter (ID) lines (i.e., drop line, lateral lines, etc.), it also works with larger-diameter lines according to the line systems and methods described in the aforementioned U.S. patent application Ser. No. ______, entitled “Maple syrup line system with increased diameter lines and fittings.” Accordingly, the description of the line system 208 below includes embodiments using both conventional 5/16″ ID lines as well as the aforementioned larger-diameter lines, or a combination thereof.

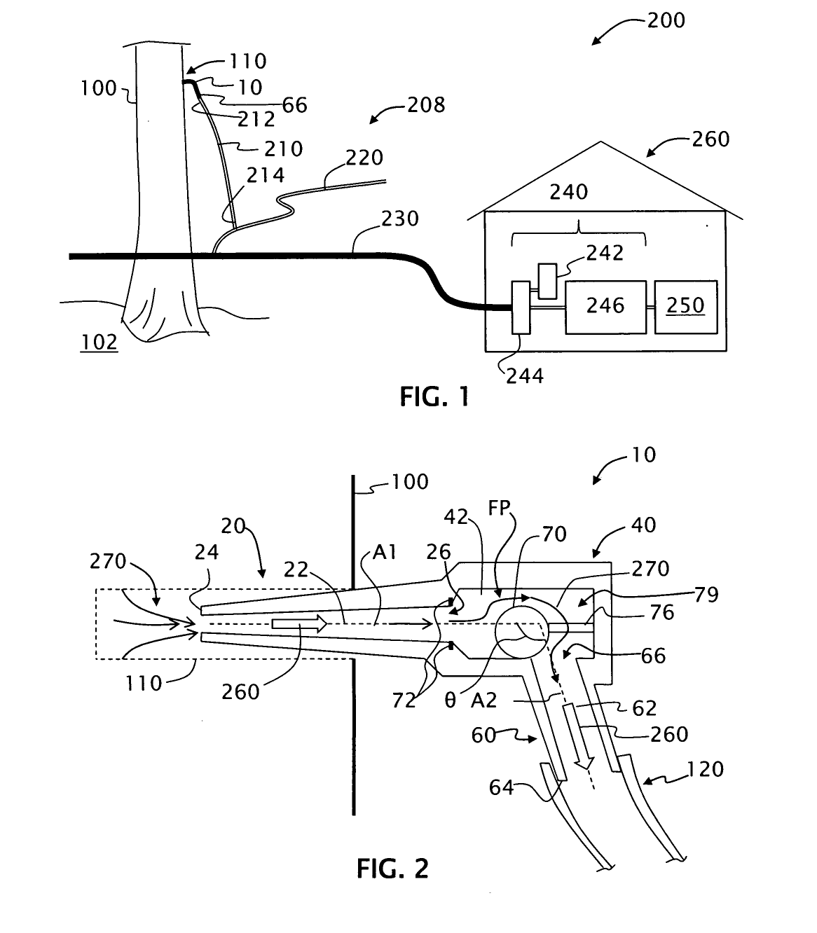

FIG. 1 shows a schematic diagram of an example maple syrup production system 200 that includes a maple syrup spout (“spout”) 10 connected to tree 100 at a taphole 110 formed therein. Spout 10 is described in greater detail below. System 200 includes a line system 208 that includes a dropline 210, a lateral line 220 and a mainline 230. A first end 212 of a dropline 210 is fluidly connected to an output end 66 of spout 10 while the other end 214 is fluidly connected to lateral line 220.

Lateral line 220 in turn is operably connected to mainline 230, which in turn is operably connected to vacuum pump system 240 that includes a vacuum pump 242, an extractor 244 and a sap storage tank 246. An evaporator 250 is operably connected to vacuum pump system 240. Vacuum pump system 240, extractor 244, storage tank 246 and evaporator 250 are shown as housed in a sugarhouse 260. System 200 thereby provides vacuum-assisted fluid communication between taphole 110 and evaporator 250 so that sap can flow from tree 100 to the evaporator. It is noted here that “fluid communication” refers to both the sap as a fluid and the air in the line system as a “fluid.” Said differently, line system 208 is sufficiently air-tight so that vacuum system 240 can pull a sufficient vacuum (e.g., 15-28 inches of mercury).

FIG. 2 is a schematic cut-away close-up side view of an example embodiment of maple spout 10 according to the present invention as used in maple syrup production system 200 of FIG. 1. Maple spout 10 in includes a nose section 20, a main body section 40 that defines an interior chamber 42 therein, and a neck section 60. In an example embodiment, nose section 20 is tapered to facilitate insertion into taphole 110. Nose section 20 defines a nose (input) channel 22 having an open distal end 24, an open proximal end 26, and a central axis A1. Proximal channel end 26 is open to interior chamber 42.

Neck section 60 defines a neck (output) channel 62 having a central axis A2 and an open distal end 64 and an open proximal end 66. Output channel 62 is connected to chamber 42 at open proximal end 66. In an example embodiment, channel central axes A1 and A2 intersect within chamber 42 at an angle θ, where angle θ is preferably a right angle or an obtuse angle. Input channel 22 and output channel 62 are fluidly connected via a flow path FP that passes through chamber 42 in first operational state referred to herein as the “flow” or “ON” operational state.

Chamber 42 contains a blocking member 70. In an example embodiment, blocking member 70 is free to move (i.e., “float”) within the chamber generally along the direction of axis A1, and is captive within the chamber. Blocking member 70 is preferably sized to be larger than the input channel proximal end 26 and is generally configured so that it can block off (seal) input channel 22 at the proximal end when the blocking member is brought into contact therewith to prevent fluid communication between the input channel and chamber 42 over flow path FP. This geometry represents a second operational state of spout 10, also called the “blocking” or “OFF” operational state.

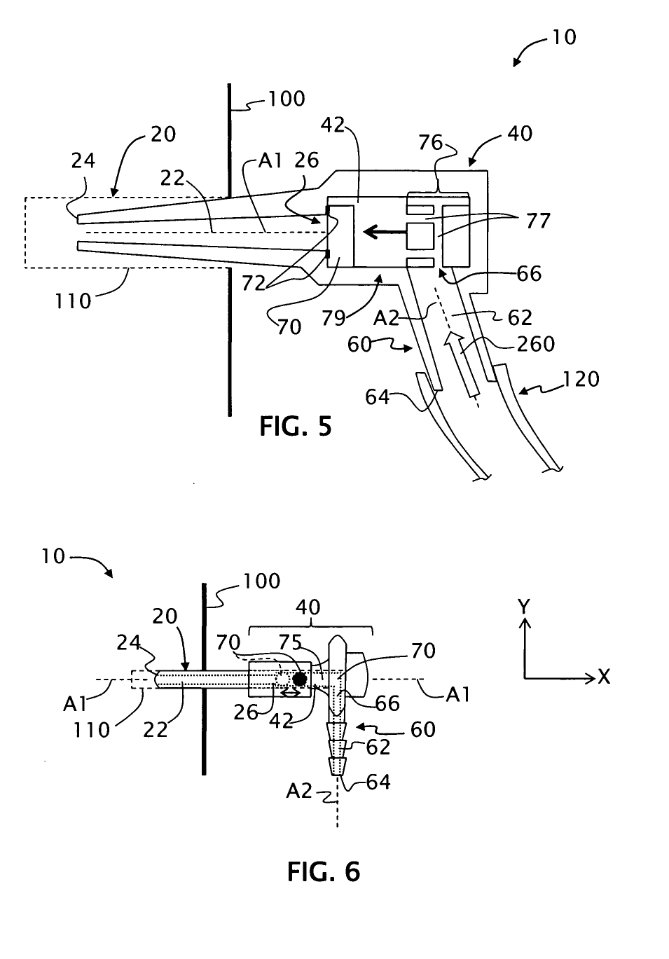

In one example embodiment, floating blocking member 70 is a ball and input channel proximal end 26 has a frustro-conical shape that accommodates the ball to form a leak-proof seal. In another example embodiment, floating blocking member 70 is a disk and input channel proximal end 26 is flat and accommodates the disc to form a leak-proof seal (see FIG. 4 and FIG. 5). In an example embodiment, input channel proximal end 26 includes a gasket 72 to help form the leak-proof seal in the blocking operational state. Other shapes and configurations for blocking member 70 and channel proximal end 26 are also possible, such as a flap-type member (not shown) that is anchored at one of its end within chamber 42 and that can rotate into place to block off input channel proximal end 26 to prevent the backflow of sap 270.

In an example embodiment of spout 10, a stand-off member 76 is arranged within chamber 42 to prevent blocking member 70 from moving into a position where it might otherwise block off flow path FP at proximal neck channel end 66. This arrangement of floating blocking member 70 and stand-off member 76 within chamber 42 forms one type of automatic backflow check valve 79 that allows for only the one-way flow of sap 270 through spout 10 in the direction from nose section 20 towards neck section 60. Thus, nose distal end 24 constitutes a spout “input end” and neck distal end 64 constitutes a spout “output end.”

In a preferred example embodiment, spout 10 is made of plastic (e.g., injection-molded plastic), as is blocking member 70 contained therein. Blocking member 70 may be, for example, a plastic or rubber ball. Other materials suitable for use as spout assemblies for maple syrup taps may also be used. Spout 10 of FIG. 2 is shown in the flow operational state wherein blocking member 70 rests against stand-off member 76 so that sap 270 can flow through the spout from input end 24 to output end 64 over flow path FP.

With reference to FIG. 1 and FIG. 2, in the operation of maple syrup production system 200, vacuum pump 240 is activated to pull a vacuum in line system 208 to facilitate the flow of sap 270 out of maple tree 100 and into spout input end 24 (see arrows 260). In this situation, the pressure differential caused by the vacuum causes blocking member 70 to move into position against stand-off member 76, thereby placing spout 10 in the flow operational state. This allows sap 270 to flow through input channel 22, through chamber 42, around the blocking member 70 contained therein, and then through channel 62 to dropline 210 via flow path FP. Sap 270 then runs through the rest of line system 208 to evaporator 250. It is noted here that sap storage tank 246 is connected to the evaporator, sometimes with an intermediate stage passing through a reverse osmosis machine (not shown).

On those occasions when the operation of vacuum system 240 is interrupted either intentionally or through a system malfunction or shutdown, the pressure differential in system 200 reverses so that there is less pressure in tree 100 than in line system 208. This causes the flow of sap 270 to reverse so that sap that has left the tree will seek to flow back into the tree. As discussed above, this is disadvantageous because microbes in the sap will initiate a reaction in tree 100 that will cause taphole 110 to “dry out.”

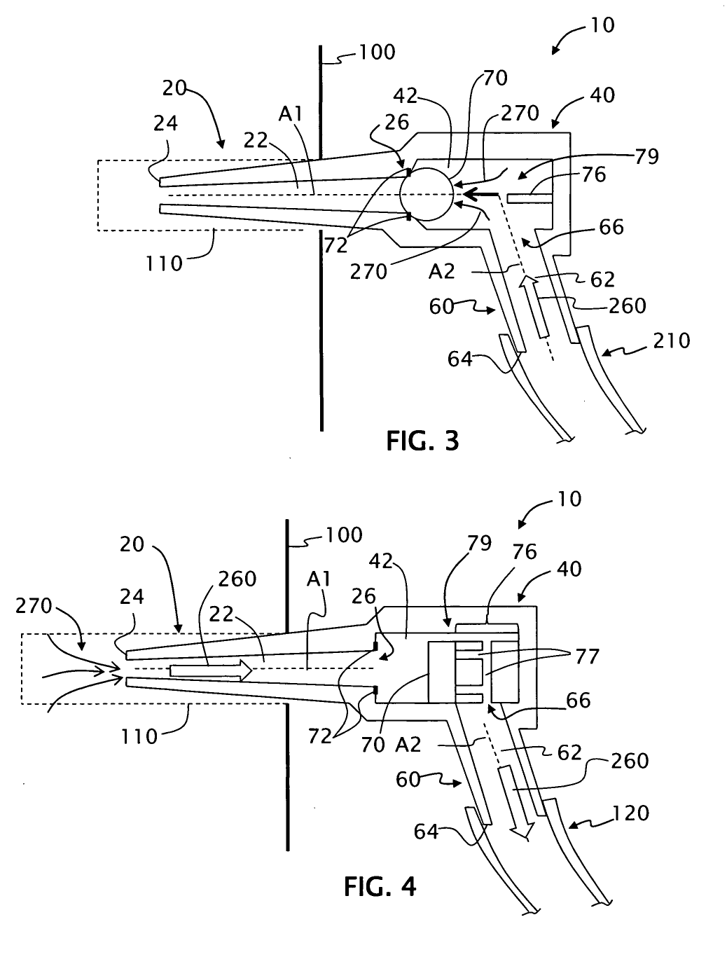

With reference now also to FIG. 3, to prevent this sap flow reversal from occurring during vacuum interruption, the reversed pressure difference automatically causes blocking member 70 to move along axis A1 until it forms a seal at input channel proximal end 26. This places spout 10 in the blocking operational state, which blocks the flow path FP and substantially prevents sap 270 from returning to taphole 110, thereby substantially preventing the taphole from drying out. The blocking operational state of spout 10 also has the added benefit of facilitating the uptake of water by tree 100 via the soil 102 rather than via dropline 210. Note also that sap 270 residing in input channel 22 is prevented from flowing back to the taphole because sealing off the input channel at proximal end 26 creates a vacuum within the input channel itself as sap tries to flow back towards input end 22. Note also that the reverse flow of sap 270 itself will cause blocking member 70 to move to the blocking position within chamber 42. The reverse flow of sap stops quickly in this case because blocking member 70 moves quickly over the short distance within chamber 42 to move into place against input channel proximal end 26.

FIG. 4 and FIG. 5 are similar to FIG. 2 and FIG. 3, respectively, and illustrate an example embodiment of spout 10 in the “flow” and “blocking” states, respectively, wherein the spout employs a floating disc-type blocking member 70. Stand-off member 76 of the disc embodiment includes a number of conduits 77 that allow for the flow path to run through the stand-off member.

An example plastic spout 10 that can be retrofitted to form the backflow check valve spout 10 of the present invention is made by the Leader Evaporator Company of Swanton, Vermont. FIG. 6 is a schematic side view of an example embodiment of the maple syrup production spout 10 of the present invention that is a retrofit to the Leader plastic maple syrup production spout. Cartesian X-Y coordinates are shown in FIG. 6 for the sake of reference.

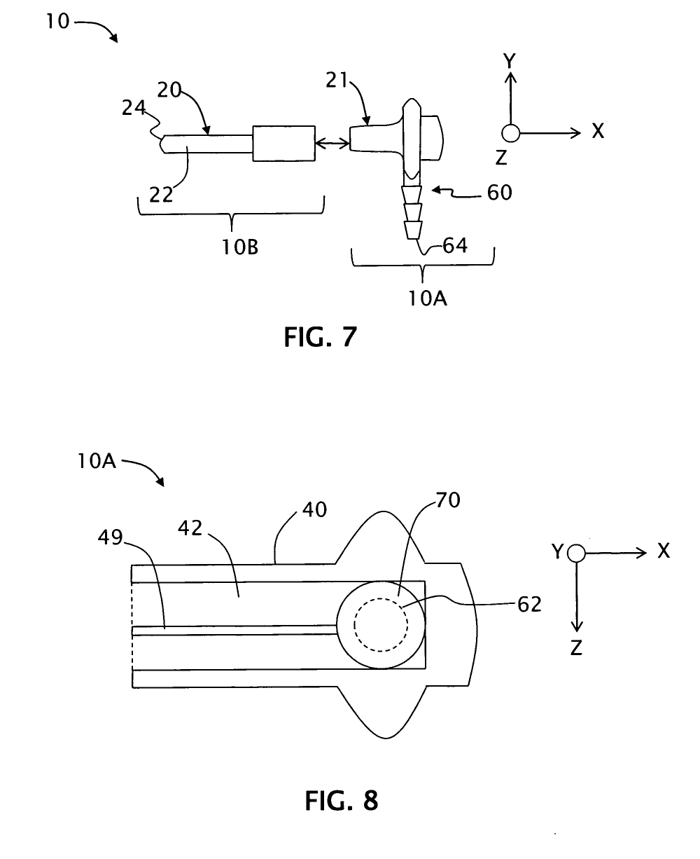

Spout 10 of FIG. 6 includes a spout section 10A and a mating adapter section 10B, as shown in the exploded view of FIG. 7. Spout portion 10A includes its own nose portion (“nose adapter section”) 21 that mates (e.g. via a snug, sliding fit) with adapter portion 10B which also constitutes the nose portion 20 of the spout. Nose portion 20 is thus “removable.” In an example embodiment, spout 10 of FIG. 6 is retrofitted with a floating ball type of blocking member 70 that is free to move within a channel-type chamber 42 generally along axis A1, i.e., along the +X and −X directions (see arrow 65).

One or more grooves (not shown in FIG. 6; see, e.g., groove 49 in FIG. 8) in channel-type chamber 42 allows for the sap to move past blocking member 70 in the “flow” operational state when the blocking member is at the rear (i.e., the right-most position in FIG. 6) of the channel-type chamber. Note that in this example embodiment of spout 10, backflow check valve 79 does require the use of a stand-off member 76.

In the blocking operational state caused by a reversal of the pressure differential between input and output ends 24 and 64 as discussed above, ball-type blocking member 70 moves along axis A1 in the −X direction from chamber portion 43 until it reaches input channel proximal end 26 and seals off input channel 22. This cuts off the (reverse) flow path FP, thereby substantially preventing the flow of sap back into taphole 110.

FIG. 8 is a cross-sectional view of spout portion 10A taken in the X-Z plane that illustrates another example embodiment of spout 10, wherein the spout of FIG. 6 includes at least one groove 49 formed in channel-type chamber 42. Groove 49 connects chamber (channel) 42 to output channel 62 to allow sap 270 to flow past ball-type blocking member 70 even while this blocking member resides in a position within channel 42 that would otherwise close of sap flow through the output channel.

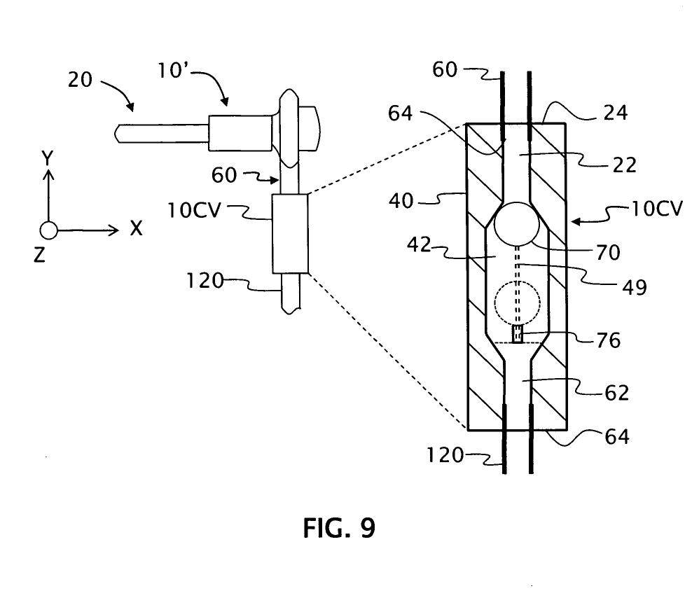

FIG. 9 is a side view of a spout 10 that includes a spout 10′ connected at its output end 64 to a backflow check valve 10CV. In this embodiment, spout 10′ does not include backflow-check capability of the other spout assemblies 10 as described above and in this sense is a conventional maple spout.

In the example embodiment of spout 10 as shown in FIG. 9, backflow check valve 10CV is connected directly to conventional spout 10′ at output end 64, but it can also be connected directly to spout 10′ via a section of dropline 120. Backflow check valve 10CV includes a body 40 with a chamber 42 that is connected at one end to an input channel 40 and at another end to an output channel 62. Blocking member 70 is provided within chamber 42. Stand-off member 76 formed within chamber 42 is configured to prevent blocking member 70 from blocking output channel 62 while also allowing sap 270 to flow through backflow check valve 10CV when vacuum system 240 is in operation. In an example embodiment similar to that shown in FIG. 8, blocking member 70 is formed from part of body 40, and one or more grooves are provided that allow for sap to flow through chamber 42 in the direction input channel 22 to output channel 62.

This embodiment of spout 10 that employs a conventional maple spout 10′ and a backflow check valve 10CV operably connected thereto allows for the use of conventional maple spouts without having to retrofit the spouts, or to use the spout 10 of the present invention that has built-in backflow-check capability.

Spout Assemblies with Interior Chamber and No Blocking Member

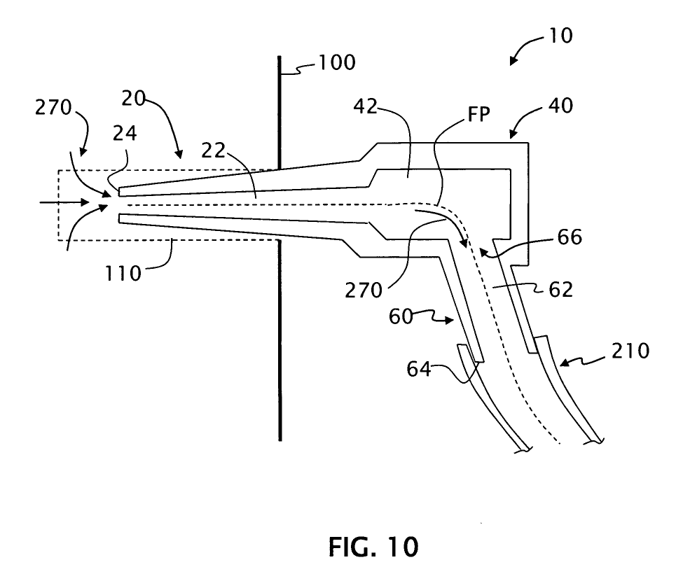

FIG. 10 is similar to FIG. 2 and illustrates an example embodiment of spout 10 that does not include blocking member 70 and gasket 72 and thus does not have backflow-checking capability. However, spout 10 still includes interior chamber 42, which in an embodiment has a cross-sectional area A42 and a volume V42 and that serves as reservoir that allows a vacuum to accumulate, thereby facilitating the flow of sap 270 through the spout and into dropline 210 over flow path FP. Interior chamber 42 also facilitates reduced liquid-liquid contact between the tubing system and the taphole, which results in a cleaner tap hole and a higher sap yield.

It is noted here that interior chamber 42 serves this function in the aforementioned spout assemblies that have backflow-checking capability. Interior chamber 42 can generally be any shape, and has a lateral dimension d42. In various non-limiting examples, interior chamber 42 has a length L42 and a main portion with a substantially constant lateral dimension d42 in the form of a diameter or a width. In some embodiments, interior chamber 42 has converging ends that join up with input and output channels 22 and 62.

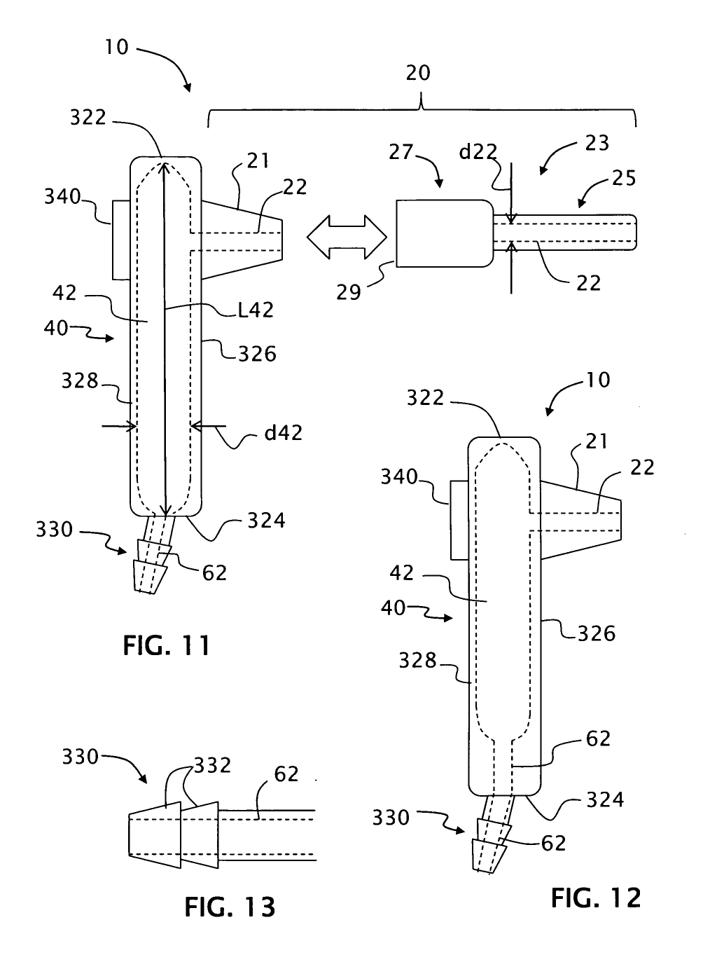

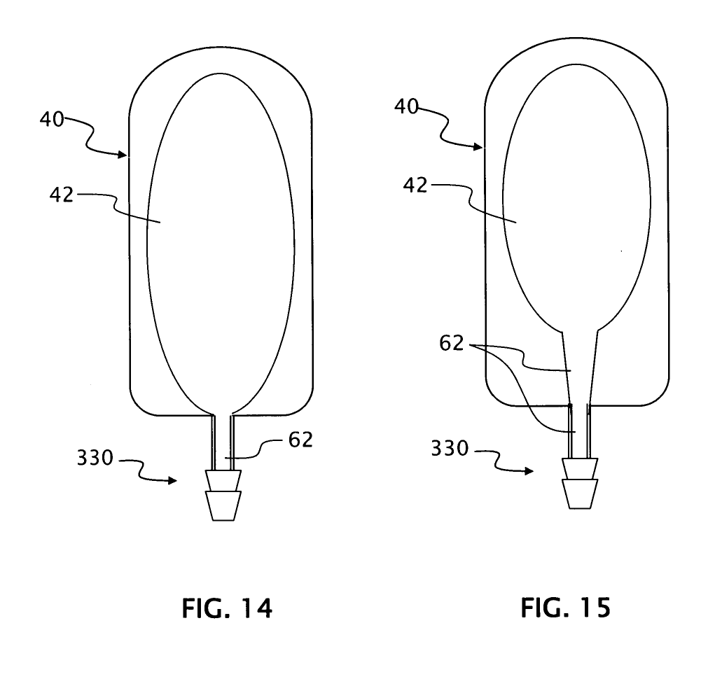

FIGS. 11 and 12 are example side views and FIGS. 14 and 15 are corresponding cut-away front-on views of another example of spout 10 that includes an interior chamber but no blocking member 70 arranged therein. Main body section 40 has an upper end 322, lower end 324, a front side 326 and a back side 328. Main body section 40 is generally rectangular but is shown with an optional rounded upper end 322. Spout 10 includes a nose adapter section 21 on front side 326 closer to upper end 322 and that includes a portion of input channel 22. Input channel has a lateral dimension (e.g., cross-sectional diameter) d22. Nose adapter section 21 is configured to accommodate a removable nose 23 having a front-end section 25 and a back end section 27. Back end section 27 has an open end 29 and is configured to slide over and snugly engage the nose adapter section so that removable nose 23 and main body section 40 are fluidly connected. Removable nose 23 includes a portion of input channel 22.

Thus, nose adapter section 21 and removable nose 23, when combined, form the above-described nose section 20 with input channel 22. Input channel 22 has a volume V22 and a cross-sectional shape with an area A22. A flat hammer base 340 is provided on back side 328 opposite nose adapter section 21so that spout adapter 10 can be hammered into the tape hole 110 (FIG. 12) without damaging main body section 40. Lower end 324 includes a fitting 330 (shown in close-up in FIG. 13) that supports at least a portion of output channel 62 external to main body section 40. In an example embodiment, fitting 330 includes ridges 332 so that dropline 210 can be press fit to the fitting to form a water-tight and vacuum-tight seal.

In the embodiment shown in FIGS. 11 and 12, interior chamber 42 extends all the way down to lower end 324 so that there is no narrow output channel 62 within main body section 40. FIGS. 14 and 15 are similar to FIGS. 11 and 12 and illustrate an example embodiment where interior chamber 42 does not extend all the way down to lower end 324 and thus utilizes an output channel 62 internal to main body section 40 to connect the interior chamber to fitting 332 and the portion of output channel 62 therein.

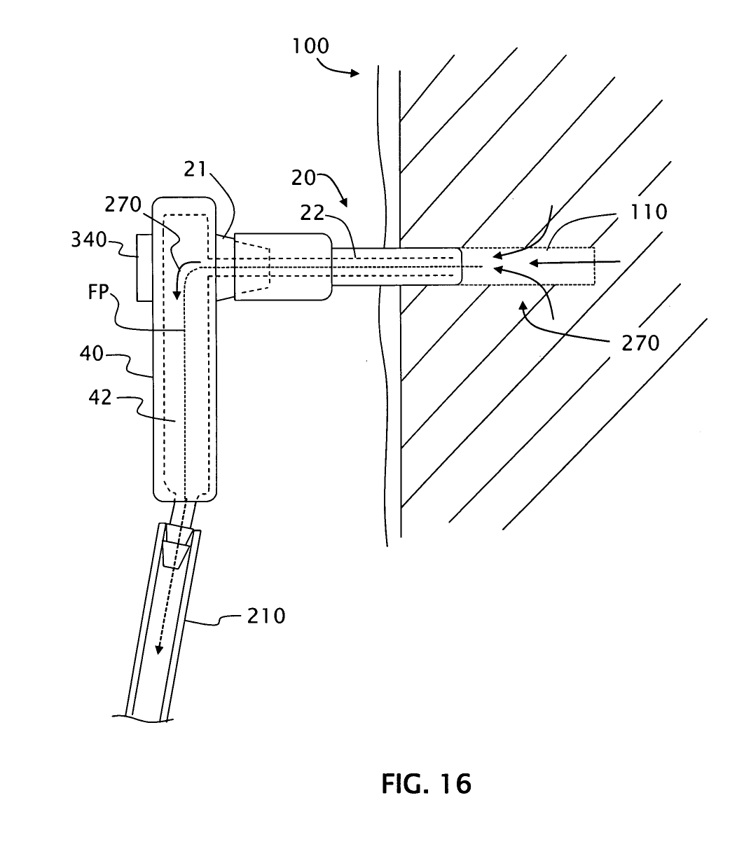

FIG. 16 is a side view that shows an example spout 10 with nose section 20 engaged with tap hole 110 of tree 100 (shown in cross-section), with sap 230 flowing out of the tap hole and through the spout and into dropline 210 over general flow path FP, as might used for example in maple syrup production system 200 of FIG. 1.

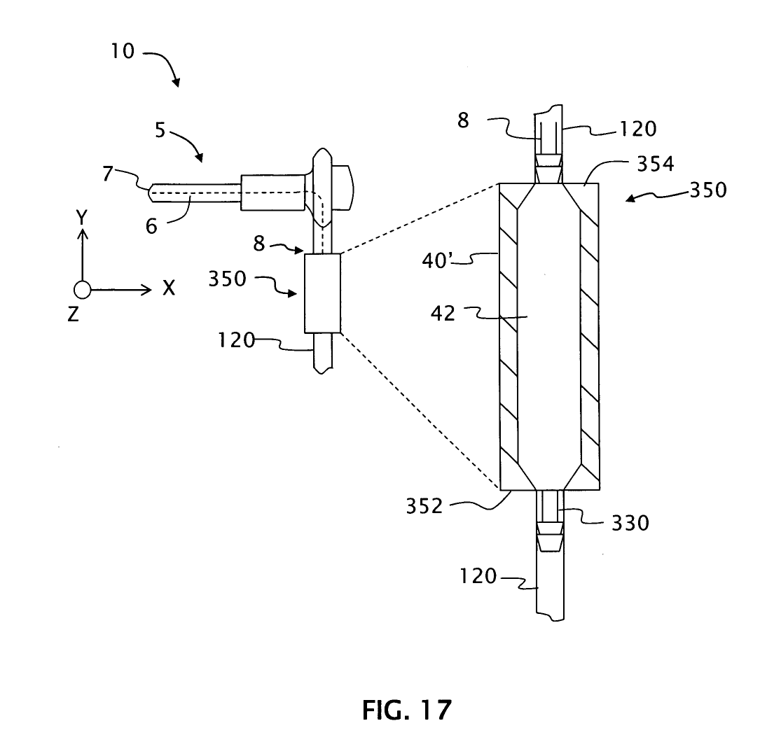

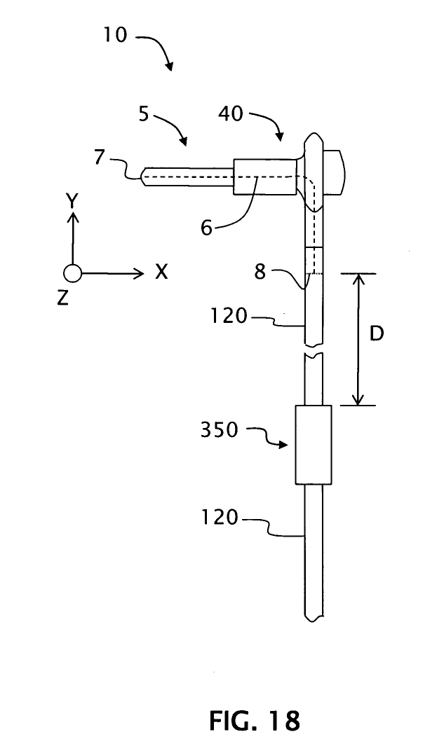

FIG. 17 is a similar to FIG. 9 and illustrates an example embodiment of a spout 10 that does not include an interior chamber. Rather, spout 10 of FIG. 17 includes a single-sized channel 6 that connects a spout input end 7 to a spout output end 8, which in an example embodiment is configured as a fitting 330. Spout 10 includes a chamber unit 350 that includes a chamber body 40 that defines interior chamber 42. Chamber unit 350 has opposite ends 352 and 354, with a fitting 330 at end 352 and a tubing section 120 at end 354. Thus, in an example embodiment, chamber unit 350 can be arranged either immediately adjacent spout 5 at output end 8, or within drop-line 210 and at a distance D from the output end 8, as shown in FIG. 18, where in an example embodiment D<40 inches. In this configuration, spout 10 can be thought of as a “spout assembly” 10′ that includes spout 10 and chamber unit 350.

In the various example embodiments discussed above, interior chamber 42 serves as reservoir that allows a vacuum to accumulate, thereby facilitating the flow of sap 270 through the spout and into dropline 210 over flow path FP (see, e.g., FIGS. 10 and 16). Generally, interior chamber 42 by definition has a size greater than that of input channel 22, i.e., a greater cross-sectional area A42 than input channel cross-sectional area A22, as well as a greater volume V42 than input channel volume V22.

For example, while it is possible to contemplate an interior “chamber” 42 to have a greater volume than input channel 22 by merely having the same cross-sectional area but a different length (i.e., a single-sized channel that runs from the input end to the output end), this would simply be an extension of input channel 22 and not an interior chamber as defined and contemplated herein.

In various example embodiments, interior chamber 42 has a cross-sectional area of at least 5% greater, at least 10% greater, at least 25% greater and at least 50% greater than input channel cross-sectional area A22. In an example where spout 10 has length L, width W and depth D dimensions (see FIGS. 12 and 1 5) of nominally L=4″, W=2″ and D=0.5″, volume V42 has a maximum of about 4 in³ (where “in”=inches). For a larger spout 10 sized with L=12″, W=2.5″ and D=0.5″, volume V42 has a maximum of about 15 in³. For a chamber 42 associated with chamber unit 350, an example maximum volume V42 is about 10 in³ based on a cylindrical chamber having a length of about 12″ and a radius of about 0.5″. Thus, in other various example embodiments, interior chamber 42 has a volume V42 such that 0.40 in³≦V42≦15.0 in³.

Example embodiments of spout 10 as described in FIGS. 10 through 18 are made of molded plastic.

It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents.

What is claimed is:

1. A spout for inserting into a taphole formed in a maple tree as part of a maple syrup production system that utilizes a line system under vacuum to convey sap from the maple tree using a drop line, comprising:
an input section defining an input channel having an end adapted for operable insertion into the taphole;
a main body section fluidly connected to the input section and having an interior chamber; and
an output channel fluidly connected to the interior chamber and configured to fluidly connect to a drop line.

2. The spout of claim 1, wherein the input channel has a cross-sectional area A22, the interior chamber has a cross-sectional area A42, and wherein A42≧(1.05) A22.

3. The spout of claim 1, wherein the interior chamber has a volume V42 such that 0.4 in³≦V22≦15.0 in³.

4. The spout of claim 3, wherein A42≧(1.5) A22

5. The spout of claim 1, wherein a portion of the output channel is internal to the main body section.

6. The spout of claim 1, wherein at least a portion of the output channel is external to the main body section.

7. The spout of claim 1, wherein the input section comprises a nose section that press fits to the main body section so that the nose section is fluidly connected to and removable from the main body portion.

8. The spout of claim 1, further comprising a drop line that press fits to the output channel.

9. A maple syrup production system, comprising:
the spout of claim 1, with its input section end inserted into the taphole; and
a line system operably connected to the spout output end and to a vacuum pump that creates a vacuum differential between the line system and the taphole that causes the sap to flow from the taphole and through the spout and through the line system.

10. A method of extracting sap from a maple tree, comprising:
providing a spout having an input end with an input channel, an output end, and a main body section having an interior chamber that is fluidly connected to the input and output ends;
forming a taphole in the maple tree;
inserting the spout input end into the taphole; and
applying a vacuum to the spout output end.

11. The method of claim 10, wherein applying the vacuum includes connecting a line system to the spout output end and applying a vacuum to the line system.

12. The method of claim 10, wherein the input channel has a cross-sectional area A22, the interior chamber has a cross-sectional area A42, and wherein A42≧(1.05) A22.

13. The method of claim 12, wherein the interior chamber has a volume V42 such that 0.4 in³≦V22≦15 in³.

14. The method of claim 10, wherein the input section includes a nose section that press fits to a nose adapter section of the main body section to form a fluid connection between the input section and the main body section.

15. A spout assembly for managing the flow of sap, comprising:
a spout having a single-sized channel that extends from an input end to an output end; and
a chamber unit fluidly connected to the output end and that includes an interior chamber.

16. The maple syrup production spout of claim 15, wherein the chamber unit is arranged within a drop line that is fluidly connected to and that is within a distance of 40 inches from the spout output end.

17. The maple syrup production spout of claim 15, wherein the interior chamber has a volume V42 such that 0.40 in³≦V42≦15 in³.

18. A maple syrup production system, comprising:
the spout of claim 15 with its input end inserted into the taphole; and
a line system operably connected to the spout output end through the chamber unit and to a vacuum pump that creates a vacuum differential between the line system and the taphole that causes the sap to flow from the taphole and through the spout, through the chamber unit and through the line system.

19. A method of extracting sap from a maple tree, comprising:
forming a taphole in the maple tree;
inserting a spout into the taphole at a spout input end, wherein the spout has a single-size channel that connects the spout input end to a spout output end;
fluidly connecting a chamber unit to the spout output end, wherein the chamber unit includes an interior chamber having a volume in the range from 0.40 in³ to 15.0 in³, including arranging the chamber unit at a distance of no more than 40 inches from the spout output end; and
applying a vacuum to the spout and the chamber unit via a drop line connected to the chamber unit.

20. The method of claim 19, wherein the chamber unit is arranged immediately adjacent and is fluidly connected to the spout output end.
